(19) United States
(12) Patent Application Publication
(10) Pub. No.: US 2011/0011313 A1
(43) Pub. Date: Jan. 20, 2011

(54) PAPERBOARD FURNITURE

(76) Inventor: Teng-Kuei YANG, Dongguan City (CN)

Correspondence Address: EGBERT LAW OFFICES, 412 MAIN STREET, 7TH FLOOR, HOUSTON, TX, 77002, US

(21) Appl. No.: 12/504,624

(22) Filed: Jul. 16, 2009

(51) Int. Cl. A47B 3/06; A47C 7/00; F16M 11/00

(52) U.S. Cl. 108/158.12

(57) ABSTRACT

The present invention provides a paperboard furniture, which is composed of composite paperboards comprising at least a corrugated board and paper stock covered thereon. The paperboard furniture contains a loading faceplate and a supporting rack for the loading faceplate. The supporting rack enables a plurality of composite paperboards to be assembled crosswise. The loading faceplate and supporting rack are mated by connecting. A connecting slot and troughing portion are formed at the bottom of the loading faceplate, whilst connecting portion and fins are formed on the supporting rack for mating with the connecting slot and troughing portion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a paperboard furniture, and more particularly to innovative furniture which is fabricated and assembled by composite paperboards.

2. Description of Related Art Including Information Disclosed Under 37 CFR 1.97 and 37 CFR 1.98

Most currently available furniture is fabricated by wooden boards. However, with the growing shortage of wooden boards, increasing fabrication cost and higher requirement on environmental-friendliness, a kind of furniture made of paperboard has been developed. This furniture is highly recognized by the customers due to its lightweight, applicability, recyclability and environmental protection advantages.

For the aforementioned paperboard furniture, structural characteristics are a crucial to resolve the existing problems, such as inconvenient fabrication and assembly, higher transportation and fabrication cost. Hence, the industrial operators must take customer-oriented steps to realize breakthrough technical progress and business objectives.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the unique present invention, paperboard furniture is mainly composed of composite paperboards, which comprise at least a corrugated board, and paper stock, being covered onto the corrugated board. Since the paper stock is pre-colored or printed with color or patterns, the shortcoming of color spraying could be addressed, so the composite paperboard presents stronger robustness, simplified fabrication technology, lower defects and processing costs as well as higher cost-effectiveness and market competitiveness. Moreover, the paperboard furniture can be directly assembled by means of connecting, making it possible to reduce the work of adhesion, facilitate the assembly and save time and cost with better environmental-friendliness while expanding the development and design.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the structure of composite paperboard of the present invention.

FIG. 2 shows a perspective view of the assembly of a preferred embodiment of the present invention.

FIG. 3 shows an exploded perspective view of the preferred embodiment of the present invention.

FIG. 4 is another exploded perspective view of the preferred embodiment of the present invention.

FIG. 5 shows an elevation view of the assembly of the preferred embodiment of the present invention.

### DETAILED DESCRIPTION OF THE INVENTION

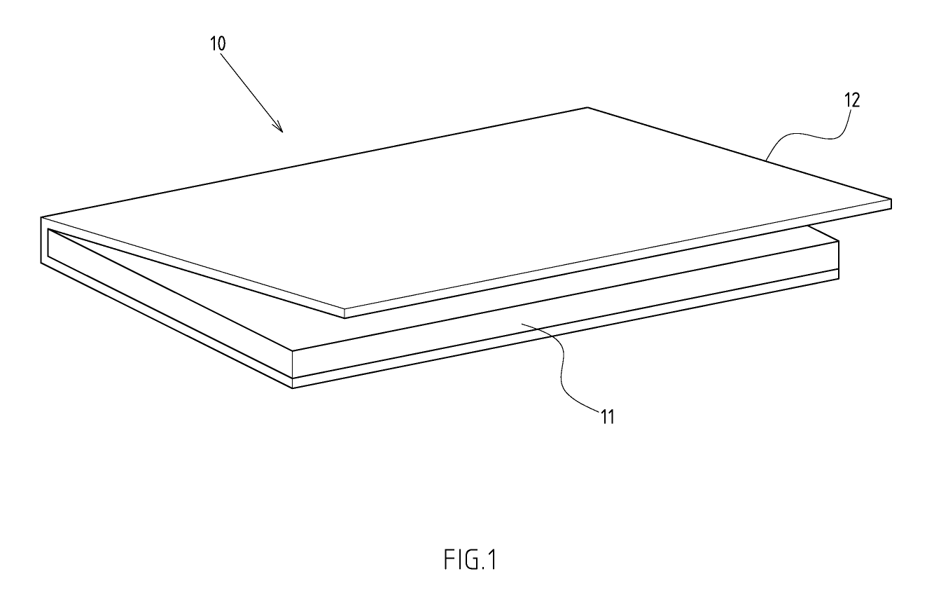

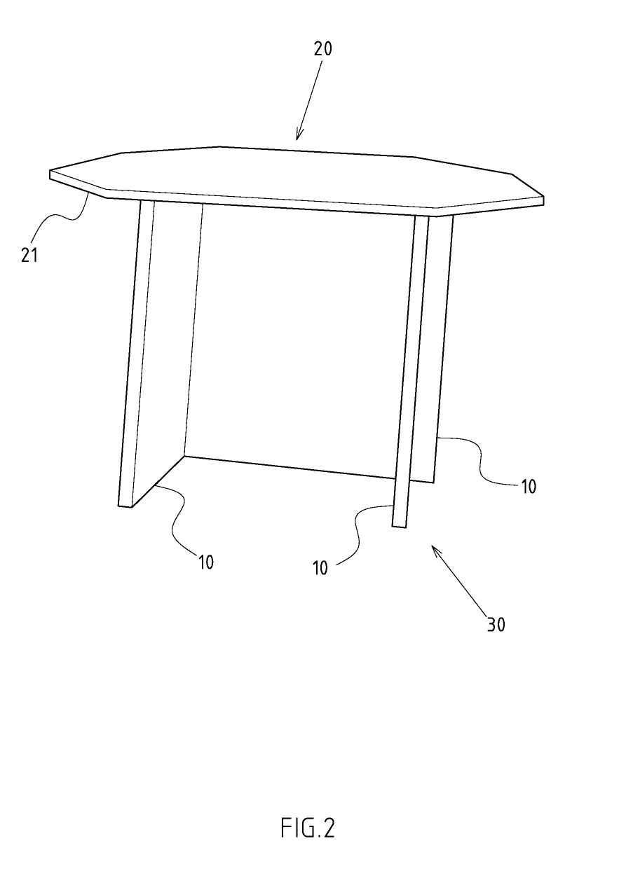

FIGS. 1-3 depict preferred embodiments of a paperboard furniture of the present invention. The embodiments are provided for only explanatory objectives with respect to the patent claims. FIGS. 2-5 depict the assembly of composite paperboard 10 shown in FIG. 1.

The paperboard furniture A is composed of composite paperboards 10, which comprise at least a corrugated board 11, onto which paper stock 12 is covered. The paper stock 12 is pre-colored or printed with color or a pattern. The paperboard furniture A contains a loading faceplate 20 and a supporting rack 30 for the loading faceplate 20. The supporting rack 30 enables a plurality of composite paperboards 10 to be assembled crosswise. The loading faceplate 20 and supporting rack 30 are mated by means of connecting. A connecting slot 22 and troughing portion 23 are formed at the bottom 21 of the loading faceplate 20, while connecting portion 32 and fins 33 are formed on the supporting rack 30 for mating with the connecting slot 22 and troughing portion 23.

A plurality of composite paperboards 10 for the supporting rack 30 are arranged in square-crossing state, so that an insertion slot 34 is arranged correspondingly, allowing the composite paperboards 10 to be assembled crosswise. Moreover, the width of the insertion slot 34 is the same with the thickness of the composite paperboard 10. The composite paperboard 10 of the supporting rack 30 is embedded into another composite paperboard 10 for transverse and longitudinal limitation via the insertion slot 34. As the width of the insertion slot 34 is the same with the thickness of the composite paperboard 10, a tight mating state is formed, such that the inner wall of the insertion slot 34 of a composite paperboard 10 can retain securely the embedded wall of another composite paperboard 10.

The supporting rack 30 is provided with two longitudinally parallel composite paperboards 10 and at least a transverse composite paperboard 10. The bottom 21 of the loading faceplate 20 is directly supported by the top of the transverse composite paperboard 10, and the connecting portion 32 of longitudinal composite paperboard 10 is embedded into the connecting slot 22. The fins 33 are extended towards both sides of the connecting portion 32 corresponding to the troughing portion 23. The supporting rack 30 of the present invention can be fastened securely since the insertion slot 34 of two longitudinal composite paperboards is interlocked with the inner wall of the insertion slot 34 of the transverse composite paperboard 10.

The longitudinal composite paperboard 10 is prefabricated in a way to form said fins 33 or prefabricated by means of assembly and connection, being covered entirely by the printed wrapping paper.

The loading faceplate 20 is stacked by a plurality of corrugated boards 11, and the top periphery of the corrugated board 11 is folded downwards to cover the plurality of corrugated boards 11.

At either side of the connecting slot 22 of the loading faceplate 20, an insertion port 25 is provided for insertion of the connecting portion 32 and fins 33 of the supporting rack 30, and the insertion ports 25 for different connecting slots 22 are arranged correspondingly.

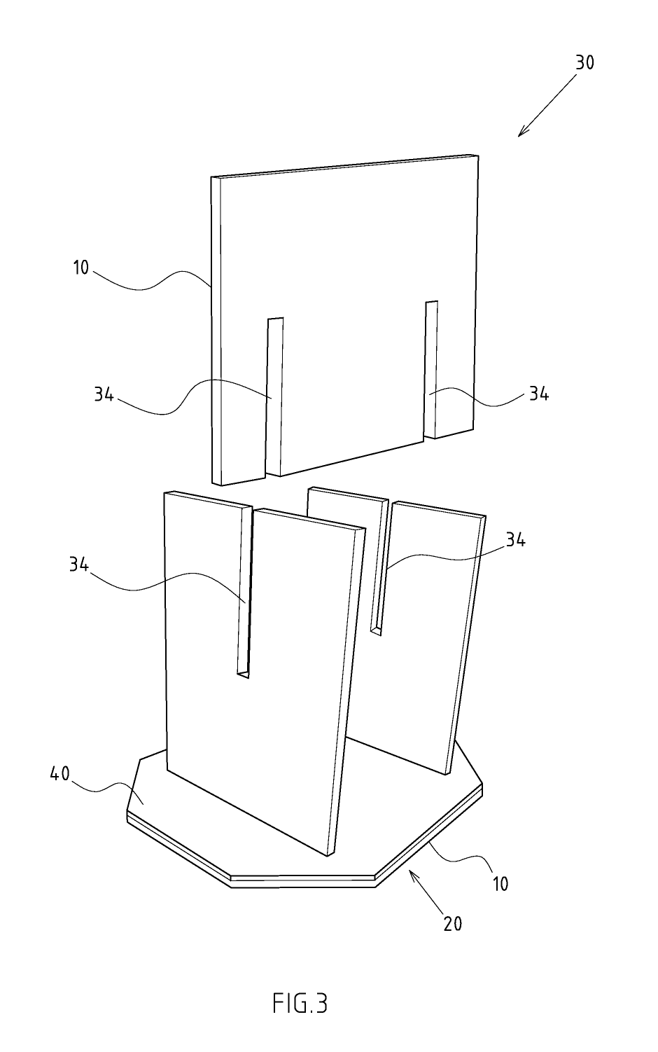

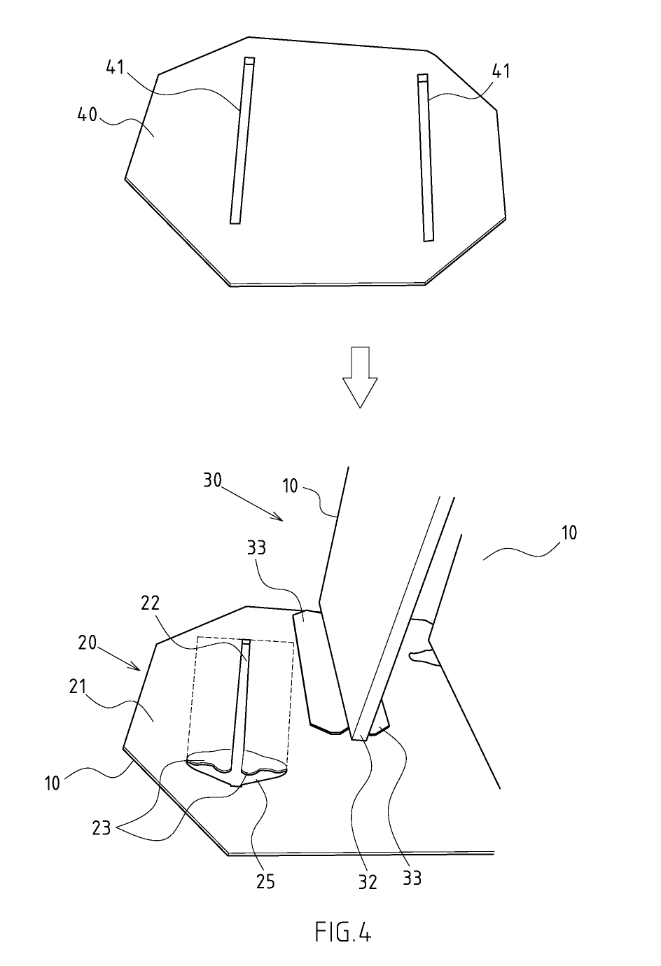

Referring to FIGS. 3 and 4, a composite paperboard 40 is additionally arranged at the bottom 21 of the assembled loading faceplate 20, so as to ensure the planeness of the bottom 21 of the loading faceplate 20 and cover the connecting portion of the supporting rack 30 and loading faceplate 20. The composite paperboard 40 is designed to strengthen the structure of the product and stabilize the connection of the supporting rack 30 and loading faceplate 20, meanwhile this can level the bottom 21 of the loading faceplate 20 for a more smooth product profile. The composite paperboard 40 can be fully covered onto the bottom 21 of the loading faceplate 20, or partially filled into the connecting portion of the bottom 21 of the loading faceplate 20 and the supporting rack 30. Moreover, the composite paperboard 40 is provided with threading holes 41 for penetration of the composite paperboard 10 of the supporting rack 30.

The paperboard furniture A can be used as either of table, chair or shelving unit.

Based upon above-specified structures, the present invention is operated as follows:

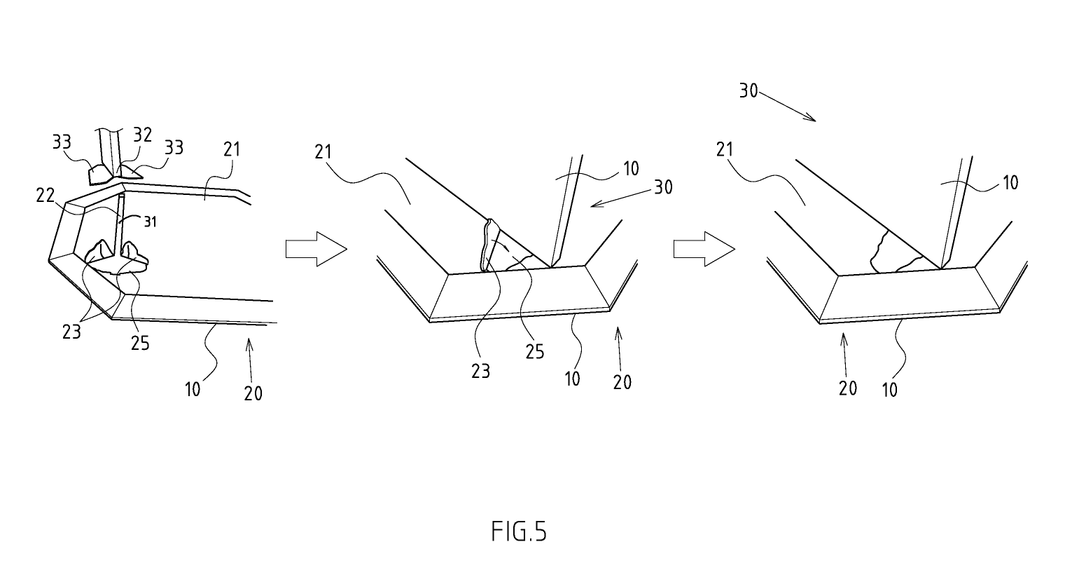

The insertion port 25 of the connecting slot 22 is formed by folded paper sheets. Referring to FIGS. 4 and 5, when it is intended for assembly, users may turn over the folded paper sheets at both sides of the insertion port 25, so the insertion port 25 is under an open state. In such a case, prepare readily the connecting portion 32 and fin 33 of the longitudinal composite paperboard 10 along the insertion port 25, permitting the connecting portion 32 to be embedded into the connecting slot 22, and the fin 33 to be assembled into the troughing portion 23. After completion of assembly, the paper sheets are folded back and then flatted, making it impossible to turn over independently due to the frictional state between the edge of the paper sheets and the connecting portion 32 of the longitudinal paperboard 10. A composite paperboard 40 is additionally pressed into it to enhance the compactness of the insertion port 25. During the actual operation, the users may also increase the fixation structure, e.g. adhering the folded paper sheets with sealing compound, and then add a layer of composite paperboard 40 to finish the mating of the longitudinal paperboard 10 and loading faceplate 20. Referring finally to FIG. 3, users may just insert the longitudinal composite paperboard 10 for assembly purpose.

1. A paperboard furniture structure comprising:
a plurality of composite paperboards, each paperboard comprising:
a corrugated board; and
paper stock covered on said corrugated board;
a loading faceplate; and
a supporting rack cooperative with said loading faceplate, said supporting rack aligning said plurality of composite paperboards to be assembled crosswise, the loading faceplate and supporting rack being connected, said loading faceplate having a connecting slot and troughing portion formed at a bottom of the loading faceplate, said supporting rack having a connecting portion and fins formed thereon, mating with the connecting slot and troughing portion.

2. The furniture structure defined in claim 1, wherein said plurality of composite paperboards for the supporting rack are arranged in square-crossing state, an insertion slot being arranged correspondingly, the composite paperboards being assembled crosswise, said insertion slot having a width identical with thickness of the composite paperboard.

3. The furniture structure defined in claim 1, wherein the supporting rack is provided with two longitudinally parallel composite paperboards and at least a transverse composite paperboard, a bottom of the loading faceplate being directly supported by the top of the transverse composite paperboard, the connecting portion of longitudinal composite paperboard being embedded into the connecting slot, the fins extending towards both sides of the connecting portion correspondingly to the troughing portion.

4. The furniture structure defined in claim 1, wherein a longitudinal composite paperboard is prefabricated in a way to form said fins or prefabricated by assembly and connection, and covered entirely by the printed wrapping paper.

5. The furniture structure defined in claim 1, wherein the loading faceplate is stacked by a plurality of corrugated boards, and the top periphery of the corrugated board is folded downwards to cover the plurality of corrugated boards.

6. The furniture structure defined in claim 1, wherein an insertion port is provided at either side of the connecting slot of the loading faceplate for insertion of the connecting portion and fins of the supporting rack, the insertion ports for different connecting slots being arranged correspondingly.

7. The furniture structure defined in claim 1, further comprising:
a composite paperboard arranged at the bottom of the assembled loading faceplate, so as to ensure the planeness of the bottom of the loading faceplate and cover the connecting portion of the supporting rack and loading faceplate.

8. The furniture structure defined in claim 1, forming either a table, chair or shelving unit.

9. The furniture structure defined in claim 1, wherein the paper stock covered onto the corrugated board is pre-colored or printed with color pattern.
